(19) United States
(12) Patent Application Publication
(10) Pub. No.: US 2010/0231071 A1
(43) Pub. Date: Sep. 16, 2010

(54) Modular stepper motor actuator

(76) Inventors: Russell Gibas, Old Saybrook, CT (US); Don Dienst, Marlborough, CT (US)

Correspondence Address: Richard A. Menelly, 18 Saco Rd., Alfred, ME, 04002, US

(21) Appl. No.: 12/381,187

(22) Filed: Mar. 10, 2009

(51) Int. Cl. H02K 7/06; H02K 15/00

(52) U.S. Cl. 310/80; 29/596

(57) ABSTRACT

A stepper motor linear actuator arrangement is formed by casting thermoplastic internal threads within a hollow metal cylinder and arranging the within a hollow metal motor stator.

### BACKGROUND OF THE INVENTION

Stepper motors are currently available for providing linear motion by means of a so-called “linear actuator” whereby an elongated threaded rod is inserted within the motor during the manufacturing process.

One example of a manufactured threaded rotor for a linear actuator is found in U.S. Pat. No. 6,774,517 entitled “Injection Molded Threaded Rotor and Manufactured Method”.

Whereas the rotor, per se, is fabricated and installed during the motor manufacturing process, it would be more economically feasible to manufacture the motor having a hollow rotor whereby the linear actuator could be installed after the motor has been assembled.

One purpose of the instant invention is to provide an integrated linear actuator arrangement that could be inserted within the motor after the motor has been completely assembled, per se.

### SUMMARY OF THE INVENTION

A stepper motor linear actuator arrangement is formed by casting thermoplastic internal threads within a hollow metal cylinder and arranging the cylinder for insertion within a hollow metal motor stator. An extended threaded rod is later inserted within the internal threads to provide linear actuator function.

### BRIEF DESCRIPTION OF THE DRAWINGS

FIG. 1A is a front perspective view of a perforated metal cylinder, which forms the outer surface of the linear actuator according to the invention;

FIG. 1B is a front perspective view of the cylinder of FIG. 1A after adhering thermoplastic threads to the inner surface thereof; and

FIG. 2 is a side perspective view of the cylinder of FIGS. 1A, 1B, after insertion within a motor-controller combination.

### DESCRIPTION OF THE PREFERRED EMBODIMENT

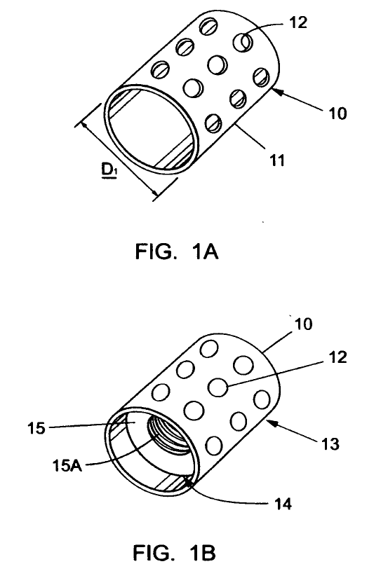

As shown in FIG. 1A, a linear actuator outer cylinder 10 is depicted in the form of a hollow metal cylinder 11 including a plurality of perforations 12. The cylinder has an outer diameter D1 of predetermined dimensions for purposes to be described below.

In accordance with the invention, the outer sleeve 10, as shown in FIG. 1B, is arranged within a mold such that an integral inner cylinder 14 is formed therein of a thermoplastic material 15 and defines a plurality of threads, as indicated at 15A.

The thermoplastic material also fills the perforations 12 such that the outer sleeve 10 becomes a single entity with the inner cylinder to complete the linear actuator nut assembly 13.

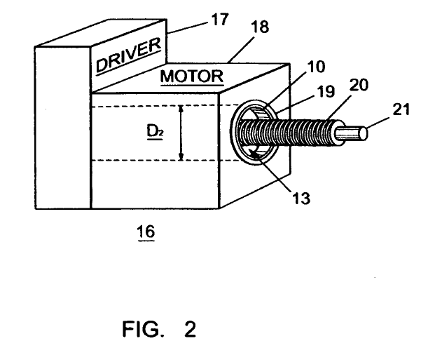

As best seen by now referring to FIG. 2, a motor controller 16, such as an IMS M-1713-1.5, including a driver 17 affixed to a stepper motor 18, is depicted wherein the hollow rotor 19 receives the nut assembly 13 therein.

The hollow rotor 19 defines a predetermined diameter D2 which receives the outer sleeve diameter D1, shown in FIG. 1A in tight-fit relation whereby the elongated threaded shaft 20, threadingly inserted within the threads 15A (FIG. 1) contained within the nut assembly 13B to allow the threaded shaft 20 to rotate in unison with the hollow rotor 19, when the stepper motor 18 is actuated to perform the linear actuator function.

When a different size motor 18 is utilized, a different size nut assembly 13 is selected to provide the tight-fit relation without having to form the hollow rotor 19 and nut assembly 13 as a single entity as described within the prior art.

Accordingly, an integral linear actuator nut assembly has been described herein for tight-fit insertion within a hollow stepper motor rotor, without having to form the rotor and nut assembly as a single unit per se.

1. A nut assembly for insertion within a stepper motor rotor for providing linear actuator function comprising:
a perforated hollow metal cylinder defining a predetermined outer diameter;
means formed within said cylinder for receiving an elongated threaded shaft;
whereby said predetermined outer diameter is sized for reception within a hollow stepper motor rotor assembly.

2. The nut assembly of claim 1 wherein said means within said exterior cylinder includes a plurality of threads for engagement with said threaded shaft.

3. The nut assembly of claim 1 wherein said means comprises an Interior cylinder of thermoplastic material formed within said exterior cylinder and extending within perforations formed therein.

4. A method for providing linear actuator function to a stepper motor comprising the steps of:
providing a nut assembly including a perforated hollow metal cylinder defining a first predetermined outer diameter and including an Interior cylinder of thermoplastic material formed within said exterior cylinder and extending within perforations formed; and
inserting said nut assembly within a stepper motor having a hollow rotor defining a second predetermined diameter formed therein, whereby said first predetermined diameter receives said second predetermined diameter in tight-fit to thereby allow said nut assembly to rotate in unison with said hollow rotor.

5. The method of claim 4 including the step of threadingly inserting a threaded shaft within said nut assembly.
